(19) United States
(12) Patent Application Publication
(10) Pub. No.: US 2022/0356049 A1
(43) Pub. Date: Nov. 10, 2022

(54) Sterilization and Deodorization Waste Bin with Dual-band Ultraviolet Tube

(71) Applicant: Handing LIN, Fuzhou (CN)

(72) Inventors: Handing LIN, Fuzhou (CN); Liming HU, Fuzhou (CN)

(73) Assignee: Handing Lin, Fuzhou (CN)

(21) Appl. No.: 17/420,938

(22) PCT Filed: Mar. 18, 2021
(86) PCT No.: PCT/CN2021/081577

§ 371 Date: Jul. 6, 2021

(30) Foreign Application Priority Data
May 20, 2020 (CN) 202010431089.2
Dec. 8, 2020 (CN) 202011419645.0

(51) Int. Cl. B66C 13/46; B66C 13/48; B66C 1/40; B66C 15/06

(52) U.S. Cl. CPC B66C 13/46; B66C 13/48; B66C 1/40; B66C 15/065

(57) ABSTRACT

The monitoring device and crane capable of displaying real-time hook bias angle to prevent oblique hoisting and anti-swaying. Its characteristics are:

a fixed pulley assembly a1 of a crane is hung on a lifting lug b2 of a crane boom b1 via a connector a3 with shackles a5, the other end of the connector a3 is connected to the fixed pulley assembly a1 with an articulated shaft a2, and the articulated shaft a2 is arranged in an orientation perpendicular to a fixed pulley axis; and a platform surface a6 perpendicular to the line of force action of the pulley block is arranged on the connector a3, an angle measuring instrument a7 is installed on the platform surface a6, The hook bias angle and direction accurately detected and displayed in real time provide a basis for the adjustment and control of the hook bias angle and direction during hoisting: It mainly includes turntable rotation centering and boom pitch centering for vertical hoisting.

### CROSS-REFERENCE TO RELATED APPLICATIONS

This application claims priority to China Application No. 202010431089.2 filed May 20, 20202, all of which are hereby incorporated herein in their entireties by reference.

### BACKGROUND OF THE INVENTION

### Technical Field

The monitoring device capable of displaying real-time hook bias angle to prevent oblique hoisting and anti-swaying, belongs to the technical field of cranes. The invention also relates to a crane comprising the monitoring device capable of displaying real-time hook bias angle to prevent oblique hoisting and anti-swaying.

### Description of Related Art

According to the latest SH/T3515-2017 Technical Specification for Construction of Large-size Equipment Hoisting Engineering in Petrochemical Industry 11.1.4, “During hoisting, the hook bias angle should be less than 1°”.

During crane hoisting work, the operation of following a hook for hook stabilization is to make the crane follow the swinging direction of the hook when a hoisted object swings to the maximum extent but has not swung back yet, so that the hook is subjected to an opposite force at the moment of swinging back, thus offsetting the backswing force and stopping the swing. The swing of the hook will increase the operation difficulty and reduce the transfer efficiency, and with the increase of a crane driver's visual range, it gets harder and harder to follow the hook, which greatly affects the production efficiency and causes potential safety hazards.

Vertical hoisting and hook bias angle monitoring in hoisting are the basic requirements for safe operation of cranes. However, a crane driver cannot determine whether the hook is in a vertical state during hoisting, or the state of a slanting hoist where a force action line of pulley block deviates from a vertical line. Whether it is from the point of preventing the slanting hoist where the force action line of pulley block deviates from the vertical line or the point of realizing vertical hoisting, this has become an urgent problem for crane operation.

A traditional electronic anti-sway system for cranes is a typical open-loop system. However, this anti-sway system is effective only for the situation that the initial hook is stationary, but the actual working condition is that most hooks have already started swinging before the crane accelerates or decelerates, so it is difficult to carry out open-loop electronic anti-sway operation.

### BRIEF SUMMARY OF THE INVENTION

The invention provides a monitoring device capable of accurately displaying real-time hook bias angle to prevent oblique hoisting and anti-swaying, and another object of the invention is to provide a crane which is provided with the monitoring device capable of accurate displaying real-time hook bias angle to prevent oblique hoisting and anti-swaying.

Why to accurately display the real-time hook bias angle: the hook bias angle is an angle by which a force application line acting on a hook of a crane pulley block deviates from a vertical line (force application direction), which is a major factor of the force application effect. According to the latest Technical Specification for Large-size Equipment, it is specified that “During hoisting, the hook bias angle should be less than 1°”. Now taking a tower crane as an example, the lifting height is assumed to be 40 m, and when the hook bias angle is 3°, the horizontal offset between the lifting height of the tower crane and the hook is 2 m at the moment when an object is hoisted, and this value can reach 4 m if the object is allowed to swing back and forth freely; for a mobile crane and an ultra-large tower crane, the lifting height can be multiplied; when the object is hoisted, There is also the overturning moment caused by the horizontal component of the hoisting load acting on the top of the boom; besides, bridge cranes used for smelting, final assembly of steam turbines, etc. often need accurate vertical hoisting;

however, as an apparatus for equipment hoisting, The crane has not yet provided a crane with an accurate display function of the hook bias angle.

In order to solve the above technical problems, the invention adopts the following technical solution. The monitoring device capable of displaying real-time hook bias angle to prevent oblique hoisting and anti-swaying, as shown in FIG. 1, wherein:

(1) detecting and displaying the hook bias angle: as shown in FIG. 2, a fixed pulley assembly a1 of a crane is hung on a lifting lug b2 of a crane boom b1 via a connector a3 with shackles a5,
the other end of the connector a3 is connected to the fixed pulley assembly a1 with an articulated shaft a2, and
the articulated shaft a2 is arranged in an orientation perpendicular to the axis of the fixed pulley; and a platform surface a6 perpendicular to the force action line of pulley block is arranged on the connector a3,
an angle measuring instrument a7 is installed on the platform surface a6,
the angle measuring instrument is connected with a controller in a crane operation room, and the detected real-time components along the X-axis and Y-axis are combined and equal to the real-time hook bias angle,
which is displayed on a display screen of the crane operation room;
(2) centering and hoisting an object according to the real-time hook bias angle;
(3) preventing a hook bias angle of the crane from exceeding an allowable value according to the real-time hook bias angle;
(4) eliminating the swing with double-pulse feedforward at the moment when the object stops and swings back according to a real-time hook swing angle and an acceleration.

Because the platform surface a6 is provide with the angle measuring instrument a7, the detected real-time components along the X-axis and Y-axis are combined and equal to the real-time hook bias angle, and the real-time deviation direction of the pulley block force application line from the vertical line is perpendicular to an intersection line of the platform surface a6 and the horizontal plane, and the real-time deviation angle of the pulley block force application line from the vertical line is located on the same plane as a real-time included angle between the platform surface a6 perpendicular to the pulley block force application line and the horizontal plane, the hook bias angle and direction accurately detected and displayed in real time provide a basis for the adjustment and control of the hook bias angle and direction during hoisting: mainly including two types of centering (turntable rotation centering and boom pitch centering); Represented by mobile cranes and bridge cranes, the controller uses a programmable logic controller (PLC).

The monitoring device capable of displaying real-time hook bias angle to prevent oblique hoisting and anti-swaying,

vertical hoisting is realized in the alternate operation of slow or extremely slow hoisting and centering of the crane based on the hook bias angle and direction which are accurately detected and displayed in real time.

The monitoring device capable of displaying real-time hook bias angle to prevent oblique hoisting and anti-swaying, firstly, a corresponding rotary handle is controlled for centering based on the position of hook bias angle which are displayed in real time, so that the turntable rotates the boom to the real-time the direction of hook bias angle (the azimuth angle of the boom is the same as the azimuth angle of the hook deflection angle), and then a corresponding boom pitching handle is controlled for centering based on the hook bias angle which is displayed in real time, (That is, change the elevation angle of the boom so that the hook bias angle is 0°). so that the real-time hook bias angle is 0°,

The monitoring device capable of displaying real-time hook bias angle to prevent oblique hoisting and anti-swaying, firstly, centering of the real-time hook bias angle and direction (FIG. 6) comprises the following steps: S1 the controller obtains the hook bias angle and direction of the crane in real time; S2 turntable rotation centering: S21 detects the direction of the real-time book bias angle, S22 Judge whether the boom deviates from the direction of the real-time hook yaw angle, if yes, go to step S23, if not, go to step S21, step S23 to make the turntable rotate the boom to the direction of the real-time hook bias angle (the azimuth angle of the boom is the same as the azimuth angle of the hook bias angle); S3 boom pitching centering: S31 detects the real-time hook bias angle, S32 judges whether the absolute value of the real-time hook bias angle is >0°,

If yes, go to step S33, if not, go to step S31, step S33 to make the real-time hook bias angle to 0° (That is, change the elevation angle of the boom so that the hook bias angle is 0°).

The monitoring device capable of displaying real-time hook bias angle to prevent oblique hoisting and anti-swaying, firstly, according to the direction of the hook bias angle displayed in real time, the corresponding bridge crane gantry handle is controlled to be centered, so that the bridge crane gantry travels and the bridge crane trolley to align the direction of the real-time hook bias angle, and then according to the hook bias angle displayed in real time, control the corresponding bridge crane trolley handle to centering, makes the bridge crane trolley travel to the real-time hook bias angle 0°.

The monitoring device capable of displaying real-time hook bias angle to prevent oblique hoisting and anti-swaying, firstly, wherein centering of the real-time hook bias angle and direction comprises the following steps: S1 the controller obtains the hook bias angle and direction of the bridge crane in real time; S2 the bridge crane gantry travels centering: S21 detects the direction of the real-time hook bias angle, S22 judges whether the bridge crane trolley deviates from the direction of the real-time hook bias angle, if yes, go to step S23, if not, go to step S21, step S23 to make the bridge crane gantry travel and the bridge crane trolley to align the direction of the real-time hook bias angle; S3 the bridge crane trolley travels centering: S31 detects the real-time hook bias angle, S32 determines whether the absolute value of the real-time hook bias angle is >0°, if yes, Go to step S33, if not, go to step S31, step S33 makes the bridge crane trolley travel to the real-time hook bias angle 0°.

The type of bridge crane for the bridge crane gantry centering and the bridge crane trolley centering further includes bridge cranes, gantry cranes, container gantry cranes, loading and unloading bridges, etc.

The monitoring device capable of displaying real-time hook bias angle to prevent oblique hoisting and anti-swaying, wherein, according to the accurately detected and real-time display hook bias angle and direction, the hook bias angle of the crane is prevented from exceeding an allowable value during hoisting based on the hook bias angle and direction which are accurately detected and displayed in real time.

When the restraint disappears in non-vertical hoisting, and the existence of inertial force in hoisting when the hoisting object stops, it can cause The hook swing phenomenon occurs;

There is also the overturning moment caused by the horizontal component of the hoisting load acting on the top of the boom; However, because it can accurately detect and display the real-time hook deflection angle, it can perform advanced monitoring including early warning or restriction for mobile cranes and super large tower cranes.

The monitoring device capable of displaying real-time hook bias angle to prevent oblique hoisting and anti-swaying, wherein, When the horizontal offset between the lifting height of mobile cranes and super large tower cranes and the hooks reaches the pre-warning value, an alarm is issued.

The monitoring device capable of displaying real-time hook bias angle to prevent oblique hoisting and anti-swaying, wherein when the mobile crane and the super large tower crane increase the torque to reach the pre-warning value, an alarm is issued; stop hoisting or moving in a large direction when exceeding the rated lifting torque.

Double-pulse feedforward can eliminate the swing, as shown in FIG. 9, where the swing period T=2π√l/g, t is deceleration time, l is rope length, and g is gravity acceleration. When the hook swings with a certain swing period (T), an isometric and isochronous pulse is applied at half swing period (T/2) (at the moment of backswing), and then the swing will be eliminated.

FIG. 8 shows a well-known hook assembly formed by direct connection of a movable pulley block A1 and a hook assembly A2 through a choke plate A3, an inertial sensor a6 is installed on a platform A5 of a movable pulley guard A4, and the inertial sensor is wirelessly connected with the controller installed in the crane operation room.

The monitoring device capable of displaying real-time hook bias angle to prevent oblique hoisting and anti-swaying, vertical hoisting is realized through centering hoisting according to the accurately detected real-time hook bias angle, which facilitates the open-loop electronic anti-shake operation. Double-pulse feedforward anti-shake operation is conducted in a way that based on the real-time hook swing angle and acceleration (absolute value) of the crane hook obtained by the controller, after the crane trolley or gantry stops, the crane hook swings back to the second half of the first cycle, the moving direction is the moving direction of the crane trolley or gantry controlled by an operation signal sent by the crane handle, and the controller controls the crane trolley or gantry to continue moving in the moving direction according to the acceleration based on the hook swing angle and acceleration acquired at this point till the hook swing angle is reduced to zero.

A crane is characterized by comprising any of above-mentioned The monitoring device capable of displaying real-time hook bias angle to prevent oblique hoisting and anti-swaying.

As shown in FIG. 2 and FIG. 4, a fixed pulley assembly a1 of a crane is hung on a lifting lug b2 of a crane boom b1 via a connector a3 with shackles a5, the other end of the connector a3 is connected to the fixed pulley assembly a1 with an articulated shaft a2, and the articulated shaft a2 is arranged in an orientation perpendicular to a fixed pulley axis; therefore, when a pulley block force application point on the fixed pulley axis deviates, the fixed pulley assembly a1 will be automatically adjusted along the articulated shaft a2 under the effect of hoisting tension of the pulley block, at this point, the fixed pulley axis inclines slightly. Because the pulley block force application line passes through the connector a3, when a platform with a platform surface a6 perpendicular to the pulley block force application line is fixedly installed on the connector a3, the pulley block force application line will be always perpendicular to the platform surface a6 in the hoisting process. Need to explain: the fixed pulley assembly a1 of the crane is hung on the lifting lug b2 of the boom b1 via the connector a3, that is, the lifting lug is set at the existing crane jib or weighing jib, jib, hanging beam, etc., and the fixed pulley assembly of the crane is hung on the set lifting lugs through the set connecting pieces.

Since the line of force action of the pulley block is always perpendicular to the platform surface during lifting, when an angle measuring instrument is fixedly installed on the platform surface of the coupling, the detected angle between the platform surface which perpendicular to the line of force action of the pulley block and the horizontal surface is numerically equal to the real-time hook bias angle of the force action line of the pulley block deviating from the vertical line.

As shown in FIG. 5, suppose the intersection angle between point b on the line m of force acting through the pulley block and the vertical line n through point b is/b, The platform surface w (ie a6 in FIG. 2) perpendicular to the force action line m of the pulley group; the angle between the platform surface W and the horizontal plane Z is La From the point b in the dihedral angle, the vertical feet of the perpendicular line drawn to the W and Z planes are C and D respectively, and the point a Ca is perpendicular to the intersection line L of the W plane and the Z plane in the plane through the C point to connect Da

[symbol]

L⊥Ca, L⊥bC, [symbol] L⊥face bCa, [symbol] L⊥ba, and [symbol] L⊥bD, [symbol] L⊥face bDa, [symbol] L⊥Da, [symbol]
∠CaD is the plane angle of the dihedral angle, the quadrilateral aCbD is coplanar with the m,n straight line, and ∠C=∠D=90°

Therefore ∠a (complementary to ∠CbD) is equal to the acute angle between the m line and the n line ∠b,

The above shows that: the real-time angle of the pulley block force application line deviating from the vertical line is equal to the real-time angle between the platform surface perpendicular to the pulley block force application line and the horizontal plane, the real-time deviation direction of the pulley block force application line from the vertical line is perpendicular to an intersection line of the platform surface and the horizontal plane, and the real-time deviation angle of the pulley block force application line from the vertical line is located on the same plane as the real-time included angle between the platform surface perpendicular to the pulley block force application line and the horizontal plane.

Therefore, an angle measuring instrument can be installed on the platform surface a6 to detect the real-time hook bias angle and direction of the pulley block force application line deviating from the vertical line.

Because the hook bias angle and direction can be accurately detected and displayed in real time, the crane driver can operate the corresponding handle accordingly to adjust the turntable to rotate in the hook bias direction and adjust the elevation angle of the boom, so as to realize vertical hoisting of the hoisted object through centering hoisting (hook bias angle 0°). therefore, the technical solution which can accurately display the real-time hook bias angle and direction has created the necessary conditions for the emergence of smart cranes.

Besides, the technical solution which can accurately display the real-time hook bias angle and direction can provide a basis for the improvement of anti-shake cranes with variable frequency speed regulation and other anti-shake cranes.

The beneficial effects of the present invention:

the hook bias angle and direction are accurately detected and displayed in real time, so that centering hoisting or monitoring of the slanting hoist by the controller as the basic requirements of the safe operation of cranes can be realized, and advanced monitoring including early warning and restriction can be carried out on the mobile crane and the ultra-large tower crane; meanwhile, the swing formed when stopping is eliminated by double-pulse feedforward, and necessary conditions are created for developing smart crane products.

### DESCRIPTION OF THE DRAWING

FIG. 1 shows the implementation diagram of real-time hook bias angle prevent oblique hoisting and anti-swaying;

FIG. 2 is an explanatory structural diagram of a hook bias angle; Reference numerals in FIG. 2: a1: fixed pulley assembly: a2: articulated shaft; a3: connector; a4: shackle 1; a5: shackle 2;

a6: platform surface; a7: angle measuring instrument;

FIG. 3 is a left sectional view of the embodiment in FIG. 2;

FIG. 4 is a schematic diagram of a lifting lug of a crane boom;

Reference numerals in FIG. 4: b1: boom; b2: lifting lug;

FIG. 5 is an explanatory diagram of detecting a hook bias angle from a pulley block force application line;

FIG. 6 is a flow chart of centering of a mobile crane centering type;

FIG. 7 is a flow chart of centering of a bridge crane centering type;

FIG. 8 is a schematic diagram of a hook assembly;

Reference numerals in FIG. 8: A1: movable pulley assembly; A2: hook assembly; A3: choke plate; A4: movable pulley guard; A5: platform; A6: inertia sensor;

FIG. 9 is a schematic diagram of double-pulse feedforward.

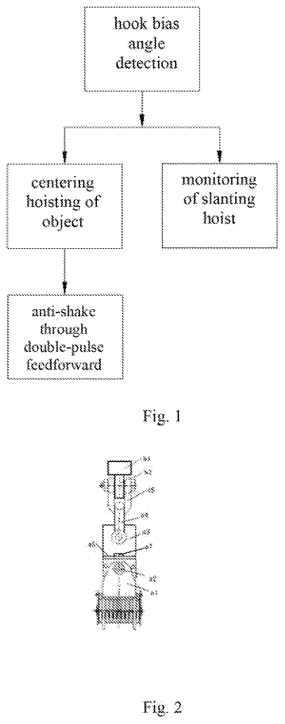

### DETAILED DESCRIPTION OF THE INVENTION

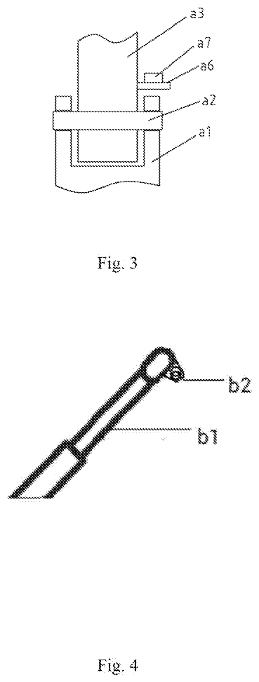

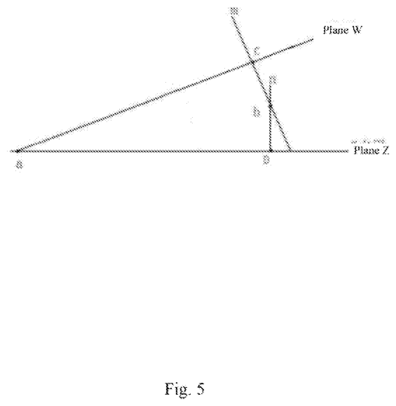

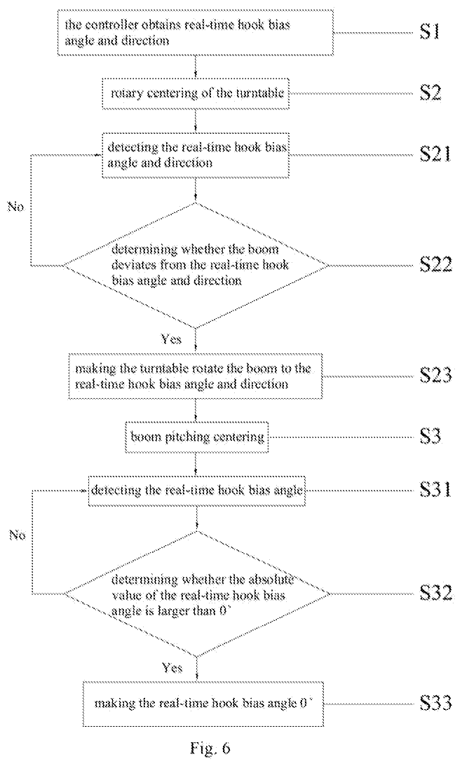

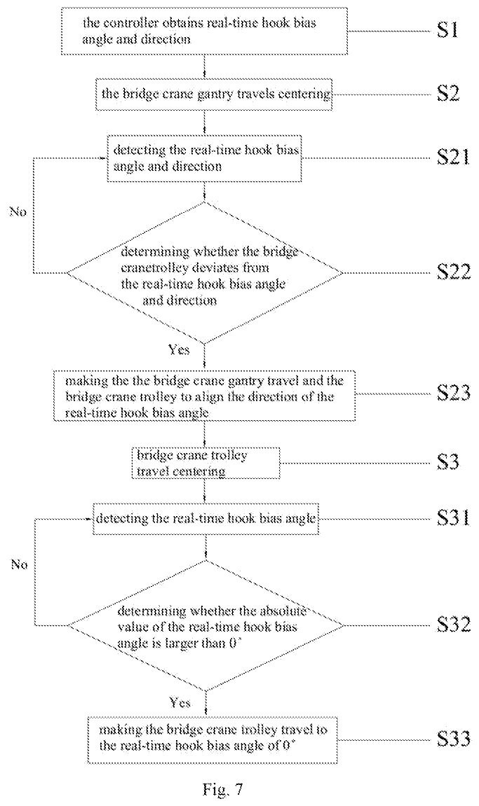

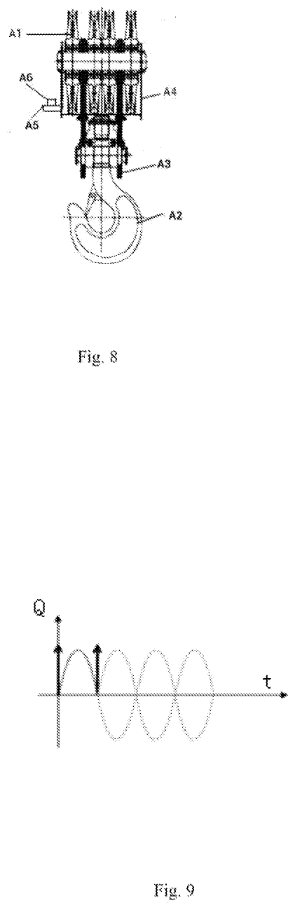

the invention adopts the following technical solution. A monitoring device capable of displaying real-time hook bias angle to prevent oblique hoisting and anti-swaying, as shown in FIG. 2,

firstly, detecting and displaying the hook bias angle

As shown in FIG. 2, a fixed pulley assembly a1 of a crane is hung on a lifting lug b2 of a crane boom b1 via a connector a3 with shackles a5,

the other end of the connector a3 is connected to the fixed pulley assembly a1 with an articulated shaft a2, and the articulated shaft a2 is arranged in an orientation perpendicular to a fixed pulley axis;
therefore, when a pulley block force application point on the fixed pulley axis deviates, the fixed pulley assembly a1 will be automatically adjusted along the articulated shaft a2 under the effect of hoisting tension of the pulley block, at this point, the fixed pulley axis inclines slightly. Because the pulley block force application line passes through the connector a3, when a platform with a platform surface a6 perpendicular to the pulley block force application line is fixedly installed on the connector a3, the pulley block force application line will be always perpendicular to the platform surface a6 in the hoisting process.

Therefore, the correct detection of the swing attitude of the hook etc. can be carried out through the platform surface a6, because the force action line of the pulley block is always perpendicular to the platform surface a6 when the load is lifted; An angle measuring instrument a7 is fixedly installed on the platform surface a6, and the detected angle between the platform surface which perpendicular to the line of force action of the pulley block and the horizontal surface is numerically equal to the real-time hook bias angle in value.

Because the detected real-time hook bias angle is determined by the angle that the line of force action of the pulley block deviates from the vertical line, the basis and rationale are clear and doubtless, and installing the angle measuring instrument on the platform surface for detection is a reliable prior art, the hook bias angle detection solution is reliable and feasible.

Installing an angle measuring instrument to detect real-time hook bias angle The BWD-VG500 dynamic measurement inclinometer (X, Y axis dynamic accuracy 0.1 degree) of Beiwei Sensing (WWW.bewis.com.cn) is selected and install it on the defined platform surface a6; the detected real-time X, Y axial components are transmitted via the bus, and the real-time hook bias angle value is equal to the real-time X, Y axial component composite value by the single-chip microcomputer; that a deviation direction of the line of force action of the pulley block from the vertical line is perpendicular to an intersection line of the platform surface a6 and the horizontal plane, and the real-time deviation angle of the line of force action of the pulley block from the vertical line is located on the same plane as the real-time included angle between the platform surface a6 perpendicular to the line of force action of the pulley block and the horizontal plane; and according to the real-time X and Y axial component polarities, the real-time hook bias angle value and orientation are accurately displayed in the crane operating room through the matching display of the prior art.

According to the hook bias angle and direction accurately detected and displayed in real time, centering hoisting or monitoring of the controller is realized, and advanced monitoring including early warning and restriction is realized.

Take the crane trolley as an example to explain the anti-shake operation of the crane hook: the inertial sensor detects the swing angle and acceleration of the crane hook in real time and sends detection results to the controller, when the crane trolley stops, the crane hook swings under the inertia; at this point, according to the acquired swing angle, acceleration, and the moving direction of the crane trolley handle operation signal, the controller controls the crane trolley in accordance with the acceleration continue to mo^{v}e in the moving direction when the crane trolley stops and swings back to the second half of the first cycle, until the crane hook swing angle reduced to zero.

It should be noted that the above-mentioned embodiments of the present invention are only examples, and for those of ordinary skill in the art, some modifications and embellishments made according to the present invention should also be regarded as the protection scope of the present invention.

What is claimed is:

1. The monitoring device capable of displaying real-time hook bias angle to prevent oblique hoisting, wherein:
(1) detecting and displaying the hook bias angle: a fixed pulley assembly (a1) of a crane is hung on a lifting lug (b2) of a crane boom (b1) via a connector (a3) with shackles (a5), the other end of the connector (a3) is connected to the fixed pulley assembly (a1) with an articulated shaft (a2), and
the articulated shaft (a2) is arranged in an orientation perpendicular to the axis of the fixed pulley; and a platform surface (a6) perpendicular to the force action line of pulley block is arranged on the connector (a3),
an angle measuring instrument (a7) is installed on the platform surface (a6),
the angle measuring instrument is connected with a controller in a crane operation room, and a real-time X-axis component and the detected real-time components along the X-axis and Y-axis are combined and equal to the real-time hook bias angle,
which is displayed on a display screen of the crane operation room;
(2) centering and hoisting an object according to the real-time hook bias angle;
(3) preventing a hook bias angle of the crane from exceeding an allowable value according to the real-time hook bias angle.

2. The monitoring device capable of displaying real-time hook bias angle to prevent oblique hoisting as claimed in claim 1, wherein
vertical hoisting or centering for vertical hoisting is realized in the alternate operation of slow or extremely slow hoisting and centering of the crane based on the hook bias angle and direction
which are accurately detected and displayed in real time.

3. The monitoring device capable of displaying real-time hook bias angle to prevent oblique hoisting as claimed in claim 1 or 2, wherein,
firstly, according to the direction of the hook bias angle displayed in real time, control the rotary handle to center, so that the turntable rotates the boom to the direction of the hook bias angle in real time, and then follow
real-time display of the hook bias angle, control the boom tilt handle to center, so that the real-time hook bias angle is 0°.

4. The monitoring device capable of displaying real-time hook bias angle to prevent oblique hoisting as claimed in claim 1 or 2, wherein,
centering for vertical hoisting of the real-time hook bias angle and direction comprises the following steps: S1 the controller obtains the hook bias angle and direction of the crane in real time; S2 turntable rotation centering: S21 detects the direction of the real-time hook bias angle, S22 Judge whether the boom deviates from the direction of the real-time book yaw angle, if yes, go to step S23, if not, go to step S21, step S23 to make the turntable rotate the boom to the direction of the real-time hook bias angle; S3 boom pitch centering: S31 detects the real-time hook bias angle, S32 judges whether the absolute value of the real-time hook bias angle is >00,
if yes, go to step S33, if not, go to step S31, step S33 to make the real-time hook bias angle to 0°.

5. The monitoring device capable of displaying real-time hook bias angle to prevent oblique hoisting as claimed in claim 1, wherein, first, according to the direction of the hook bias angle displayed in real time, the corresponding bridge crane gantry handle is controlled to be centered, so that the bridge crane gantry travels and the bridge crane trolley to align the direction of the real-time hook bias angle, and then according to the hook bias angle displayed in real time, control the corresponding bridge crane trolley handle to centering, makes the bridge crane trolley travel to the real-time hook bias angle 0°.

6. The monitoring device capable of displaying real-time hook bias angle to prevent oblique hoisting as claimed in claim 1 or 2, wherein centering for vertical hoisting of the real-time hook bias angle and direction comprises the following steps: S1 the controller obtains the hook bias angle and direction of the bridge crane in real time; S2 the bridge crane gantry travels centering: S21 detects the direction of the real-time hook bias angle, S22 judges whether the bridge crane trolley deviates from the direction of the real-time hook bias angle,
If yes, go to step S23, if not, go to step S21, step S23 to make the bridge crane gantry travel and the bridge crane trolley to align the direction of the real-time hook bias angle S3 the bridge crane trolley travels centering: S31 detects the real-time hook bias angle, S32 determines whether the absolute value of the real-time hook bias angle is >0°, if yes, go to step S33, if not, go to step S31, step S33 makes the bridge crane trolley travel to the real-time hook bias angle 0°.

7. The monitoring device capable of displaying real-time hook bias angle to prevent oblique hoisting as claimed in claim 1, wherein
the hook bias angle of the crane is prevented from exceeding an allowable value during hoisting based on the hook bias angle and direction which are accurately detected and displayed in real time.

8. The monitoring device capable of displaying real-time hook bias angle to prevent oblique hoisting as claimed in claim 7, wherein
an alarm is given when the horizontal offset between the lifting height of the crane and the hook reaches an early warning value.

9. The monitoring device capable of displaying real-time book bias angle to prevent oblique hoisting as claimed in claim 7, wherein
an alarm is given when the slanting hoist increasing torque of the crane reaches an early warning value, and stop hoisting or moving in a large direction when exceeding the rated lifting torque.

10. A crane, wherein: (1) detecting and displaying the hook bias angle: a fixed pulley assembly a1 of a crane is hung on a lifting lug b2 of a crane boom b1 via a connector a3 with shackles a5,
the other end of the connector a3 is connected to the fixed pulley assembly a1 with an articulated shaft a2, and
the articulated shaft a2 is arranged in an orientation perpendicular to the axis of the fixed pulley; and a platform surface a6 perpendicular to the force action line of pulley block is arranged on the connector a3,
an angle measuring instrument a7 is installed on the platform surface a6,
the angle measuring instrument is connected with a controller in a crane operation room, and a real-time X-axis component and the detected real-time components along the X-axis and Y-axis are combined and equal to the real-time hook bias angle,
which is displayed on a display screen of the crane operation room;
(2) centering and hoisting an object according to the real-time hook bias angle;
(3) preventing a hook bias angle of the crane from exceeding an allowable value according to the real-time hook bias angle.

11. The crane as claimed in claim 10, wherein centering for vertical hoisting of the real-time hook bias angle and direction comprises the following steps: S1 the controller obtains the hook bias angle and direction of the crane in real time; S2 turntable rotation centering: S21 detects the direction of the real-time hook bias angle, S22 Judge whether the boom deviates from the direction of the real-time hook yaw angle, if yes, go to step S23, if not, go to step S21, step S23 to make the turntable rotate the boom to the direction of the real-time hook bias angle; S3 boom pitch centering: S31 detects the real-time hook bias angle, S32 judges whether the absolute value of the real-time hook bias angle is >0°,
If yes, go to step S33, if not, go to step S31, step S33 to make the real-time hook bias angle to 0°.

12. The crane as claimed in claim 10, wherein centering for vertical hoisting of the real-time hook bias angle and direction comprises the following steps: S1 the controller obtains the hook bias angle and direction of the bridge crane in real time; S2 the bridge crane gantry travels centering: S21 detects the direction of the real-time hook bias angle, S22 judges whether the bridge crane trolley deviates from the direction of the real-time hook bias angle,
if yes, go to step S23, if not, go to step S21, step S23 to make the bridge crane gantry travel and the bridge crane trolley to align the direction of the real-time hook bias angle; S3 the bridge crane trolley travels centering: S31 detects the real-time hook bias angle, S32 determines whether the absolute value of the real-time hook bias angle is >0°, if yes, go to step S33, if not, go to step S31, step S33 makes the bridge crane trolley travel to the real-time hook bias angle 0°.

13. The crane as claimed in claim 10, wherein an alarm is given when the horizontal offset between the lifting height of the crane and the hook reaches an early warning value.

14. The crane as claimed in claim 10, wherein an alarm is given when the slanting hoist increasing torque of the crane reaches an early warning value, and stop hoisting or moving in a large direction when exceeding the rated lifting torque.
